(19) United States
(12) Patent Application Publication
(10) Pub. No.: US 2016/0031733 A1
(43) Pub. Date: Feb. 4, 2016

(54) Method and Apparatus for Fluid Purification

(71) Applicant: Greg Scheurer, Mystic, CT (US)

(72) Inventor: Greg Scheurer, Mystic, CT (US)

(21) Appl. No.: 14/815,254

(22) Filed: Jul. 31, 2015

Related U.S. Application Data
(60) Provisional application No. 62/032,150, filed on Aug. 1, 2014.

(51) Int. Cl. C02F 1/72; B01J 19/08

(52) U.S. Cl. CPC C02F 1/72; B01J 19/088; B01J 2219/0871; B01J 2219/0805; B01J 2219/0875; B01J 2219/0894

(57) ABSTRACT

A fluid purification system (FPS) is provided and includes a fluid inlet, an injection manifold defining at least one manifold fluid flow path and at least one gas/fluid flow path. The injection manifold is configured to receive a fluid flowing into the fluid inlet such that the fluid flows through the manifold fluid flow path, wherein the injection manifold is configured to controllably divert at least a portion of the fluid to flow through the fluid/gas flow path and back into the manifold fluid flow path. The FPS further includes a singlet oxygen generator for generating singlet oxygen O₁ communicated with the injection manifold such that the singlet oxygen O₁ is controllably injectable into the gas/fluid flow path and a contact chamber, wherein the contact chamber is in flow communication with the manifold fluid flow path to receive the fluid flowing within the manifold fluid flow path.

### CROSS REFERENCE TO RELATED APPLICATIONS

This application is related to and claims the benefit of the filing date of U.S. Provisional Patent Application Ser. No. 62/032,150 filed Aug. 1, 2014, the contents of which are incorporated herein by reference in its entirety.

### FIELD OF THE INVENTION

The present invention relates to the purification of fluids and more particularly to the purification of fluids via an apparatus and method that uses singlet oxygen O₁.

### BACKGROUND OF THE INVENTION

Clean fresh water is one of the world's most vital resources and an essential element to life and any civilization. The United States relies on public and private water systems to deliver over 44 billion gallons of clean water every day to homes, schools and businesses. Typically water from public water systems are treated to remove chemicals, particulates and bacteria. This clean potable water is then used for cooking, cleaning, drinking, bathing and other things. As such, when water is polluted it is devastating to both the environment and health of the people living in the environment.

In fact, one of the biggest problems of the 21^{st} century is that clean water for consumption and other uses, such as watering crops and industrial applications, is becoming less and less available. One reason for this is that as the population increases, the water use increases. Thus, the amount of available fresh water per person is constantly being decreased due to increase in population. Additionally, contamination from fertilizers, pesticides, sewage runoff and industrial releases (controlled or uncontrolled) find its way into the fresh water aquifers and reservoirs thereby contaminating the fresh water sources used by the population. This further adds to the decrease in available fresh water. Moreover, as the population increases so does the need for industry, many of which need clean water for their daily operations.

One way to address this problem is to purify water that has become contaminated. Specifically, water purification involves removing undesirable chemicals, biological contaminants, solids and gases from water that is to be consumed or used for other purposes, such as medical, pharmaceutical, chemical and industrial applications. Current methods for purifying water and other fluids typically involve either physical processes, biological processes or chemical processes, where the physical processes typically involve filtration, sedimentation and/or distillation, the biological processes typically involve slow sand filters or biological active carbon and the chemical processes typically involve flocculation and chlorination along with electromagnetic radiation (e.g. ultraviolet light).

Unfortunately however, each of these methods are either inefficient, cost a great deal of money to implement or do not result in water that is clean enough for consumption or use in the needed applications.

### SUMMARY OF THE INVENTION

A fluid purification system (FPS) is provided and includes a fluid inlet for receiving a fluid, an injection manifold defining at least one manifold fluid flow path and at least one gas/fluid flow path, wherein the at least one gas/fluid flow path is in flow communication with the at least one manifold fluid flow part, the injection manifold being configured to receive the fluid flowing into the fluid inlet such that the fluid flowing into the fluid inlet flows through the at least one manifold fluid flow path, wherein the injection manifold is further configured to controllably divert at least a portion of the fluid flowing through the at least one manifold fluid flow path to flow through the at least one fluid/gas flow path and back into the at least one manifold fluid flow path. The FPS further includes a singlet oxygen generator for generating singlet oxygen O₁ communicated with the injection manifold such that the singlet oxygen O₁ is controllably injectable into the at least one gas/fluid flow path and at least one contact chamber defining a contact chamber flow path, wherein the contact chamber is in flow communication with the at least one manifold fluid flow path to receive the fluid flowing within the at least one manifold fluid flow path. The FPS further includes at least one fluid outlet in flow communication with the at least one contact chamber to allow fluid flowing within the at least one contact chamber to flow out of the at least one contact chamber.

A singlet oxygen generator for generating single oxygen O₁ is provided, wherein the singlet oxygen generator includes an outer element having an outer element first end, an outer element second end, an outer element first opening and an outer element second opening. The outer element defines an outer element cavity having an outer element cavity surface and extends between the outer element first end and the outer element second end to communicate the outer element first opening with the outer element second opening. The singlet oxygen generator includes an inner structure having an inner structure outer surface, an inner structure first end, an inner structure second end, an inner structure first opening and an inner structure second opening, wherein the inner structure defines an inner structure cavity which extends between the inner structure first end and the inner structure second end to communicate the inner structure first opening with the inner structure second opening, wherein the inner structure is configured to fit within the outer element cavity such that the inner structure outer surface is separated from the outer element cavity surface by a predetermined space. The singlet oxygen generator also includes a flow control element, wherein the flow control element is associated with the inner structure outer surface to be located between the inner structure outer surface and the outer element cavity surface.

A method for purifying a fluid via a fluid purification system is provided, wherein the fluid purification system includes an injection manifold defining a first fluid flow path, a first gas/fluid flow path, a second fluid flow path, a second gas/fluid flow path, a first contact chamber, a second contact chamber and at least one fluid outlet in flow communication with the first and second contact chambers to allow fluid flowing within the first and second contact chambers to flow out of the first and second contact chambers. The method includes introducing the fluid into the injection manifold of the fluid purification system such that the fluid flow is split into a first fluid flow flowing in a first fluid flow path and a second fluid flow flowing in a second fluid flow path, diverting at least a portion of the first fluid flow flowing in the first fluid flow path to flow in the first gas/fluid flow path and at least a portion of the second fluid flow flowing in the second fluid flow path to flow in the second gas/fluid flow path, injecting singlet oxygen O₁ into the first and second gas/fluid flow paths to generate a fluid having a combination of fluid and gas flowing through the first and second gas/fluid flow paths, and directing the gas/fluid combination flowing within the first gas/fluid flow paths through a first mixing device to generate a first mixed gas/fluid combination and the gas/fluid combination flowing within the second gas/fluid flow paths through a second mixing device to generate a second mixed gas/fluid combination. The method further includes combining the first mixed gas/fluid combination with the first fluid flow to generate a first combined gas/fluid flow mix and the second mixed gas/fluid combination with the second gas/fluid flow to generate a second combined gas/fluid flow mix and directing the first combined gas/fluid flow mix through the first contact chamber and the second combined gas/fluid flow mix through the second contact chamber.

### BRIEF DESCRIPTION OF THE DRAWINGS

The foregoing and other features and advantages of the present invention will be more fully understood from the following detailed description of illustrative embodiments, taken in conjunction with the accompanying drawings in which like elements are numbered alike in the several Figures:

FIG. 1 is a side perspective view of a fluid purification system, in accordance with one embodiment of the invention.

FIG. 2 is a side isometric sectional view of a purification module of the fluid purification system of FIG. 1.

FIG. 3 is a side view of the buffer tanks for use with the fluid purification system of FIG. 1.

FIG. 4 is a side view of the first filter for use with the fluid purification system of FIG. 1.

FIG. 5A is a side view of the second filter for use with the fluid purification system of FIG. 1.

FIG. 5B is a side view of an inline static mixer contain within the purification module for use with the fluid purification system of FIG. 1.

FIG. 5C is a side perspective view of a module injection manifold for use with the fluid purification system of FIG. 1.

FIG. 5D is a side perspective view of an oxygen O₁ generator for use with the fluid purification system of FIG. 1.

FIG. 5E shows a side view of the inner element and the outer element for use with the oxygen O₁ generator of FIG. 5D.

FIG. 5F shows a view of the first ends of the inner element and the outer element of the oxygen O₁ generator of FIG. 5D.

FIG. 5G shows a view of the second ends of the inner element and the outer element of the oxygen O₁ generator of FIG. 5D.

FIG. 5H shows a view of the first end of the outer element of the oxygen O₁ generator of FIG. 5D.

FIG. 6A is a side perspective view of a fluid purification system, in accordance with another embodiment of the invention.

FIG. 6B is a side sectional view representing a hydrocyclone separator for use in the fluid purification system of FIG. 6A, in accordance with another embodiment of the invention.

FIG. 7 is an operational block diagram illustrating one embodiment of a method 500 for purifying a fluid.

FIG. 8 is an operational block diagram illustrating one embodiment of a purification module for use with the purification system of FIG. 1 and FIG. 6A.

### DETAILED DESCRIPTION OF THE INVENTION

It should be appreciated that the present invention provides a unique and novel Fluid Purification System (FPS) and method for purifying a fluid by controlling the flow scheme within a plasma generator and using the generated singlet oxygen O₁ to purify the fluid. This invention overcomes the shortfalls of the known designs of such chambers where a gas in injected into a gap inside a generator and is not forced to pass by all the potential excitation sections of the plasma generator. The elements of the plasma generator are metal machined parts with a glass dielectric insulator, and as such, these parts are not perfect and glass is not perfect. These imperfections cause hot and cold spots within the plasma generator where the electric spark is stronger and weaker. Thus, sterilization is not uniform. The present invention forces uniformity and increases the actual time in which the O2 is in contact with the generator. In some embodiments, the quality of the gas may be greater than 30 percent using the same O2 flow and power as standard designs. Additionally, not only is the flow of gas through the plasma generator controlled to produce a high quality gas for use in the sterilization process, the invention controls the flow of the liquid to gas interface through the balancing of the two parallel paths of the mixing (injection) manifold. Furthermore, the flow through the contact chambers is controlled to add time and to provide for enhanced mixing of fluid and gas. Accordingly, while the prior art is only able to achieve water having a dissolved oxygen level (saturation) of 8.4 ppm, the present invention is able to achieve water having a dissolved oxygen level (saturation) of 24 ppm and maintain that level for several weeks.

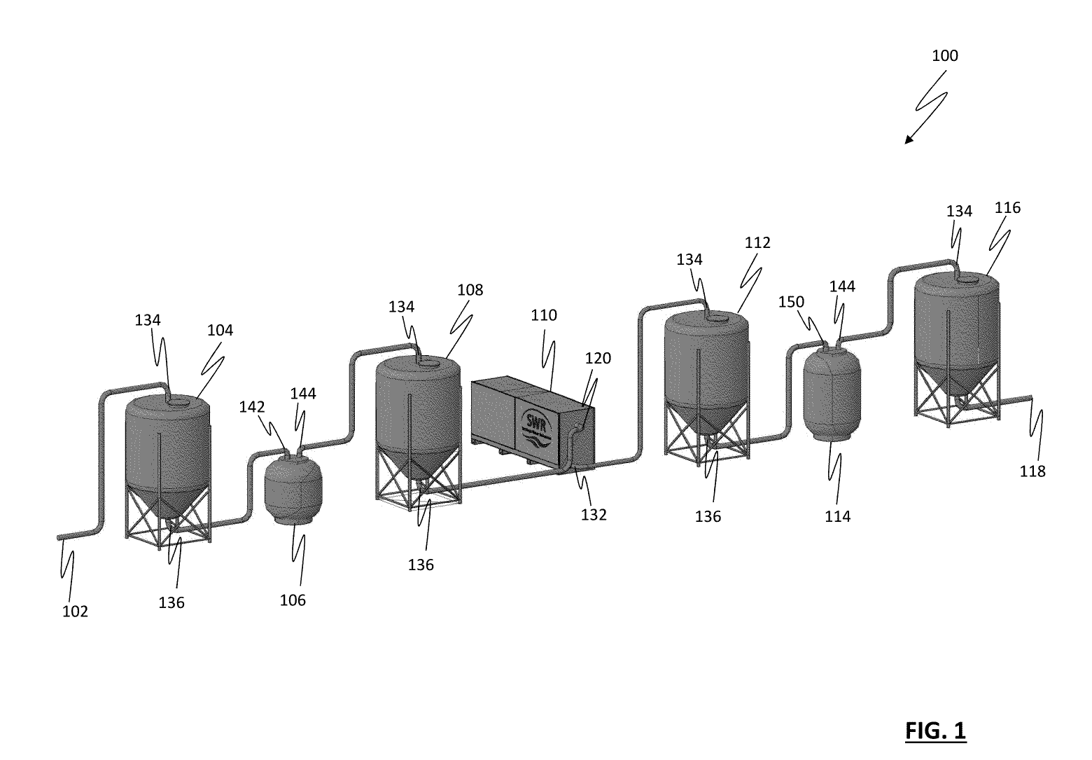

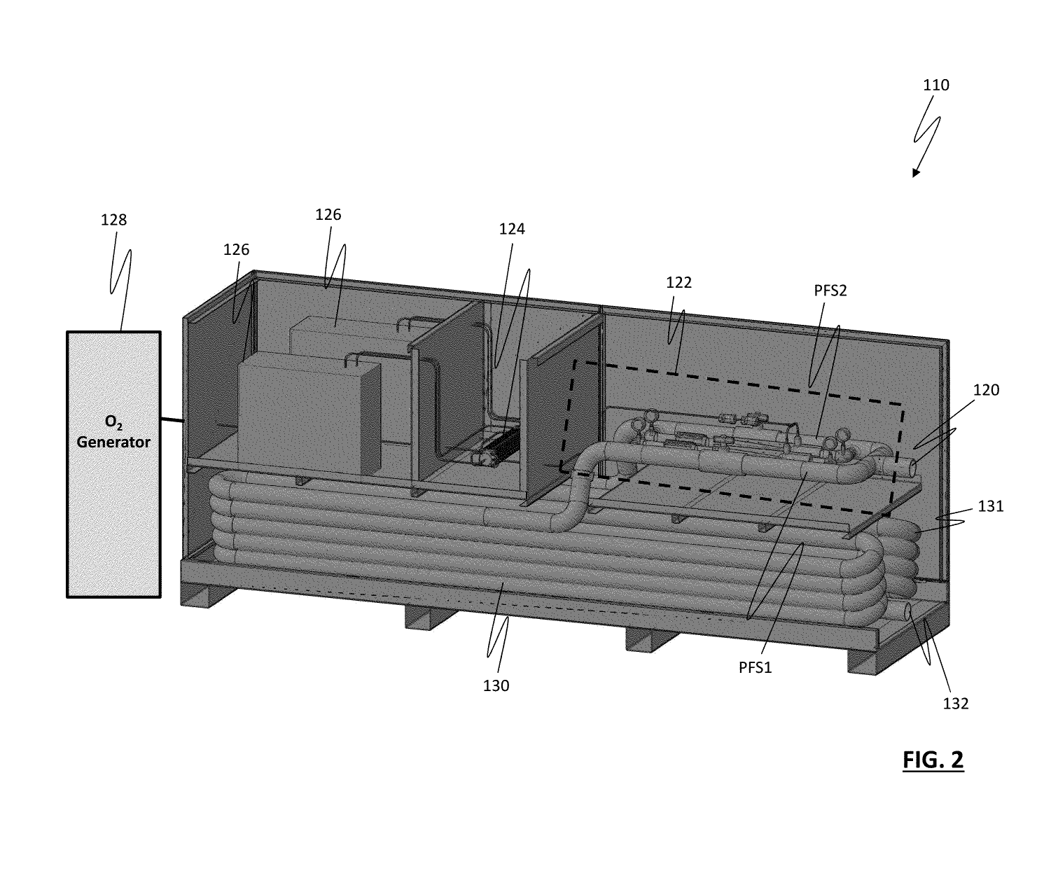

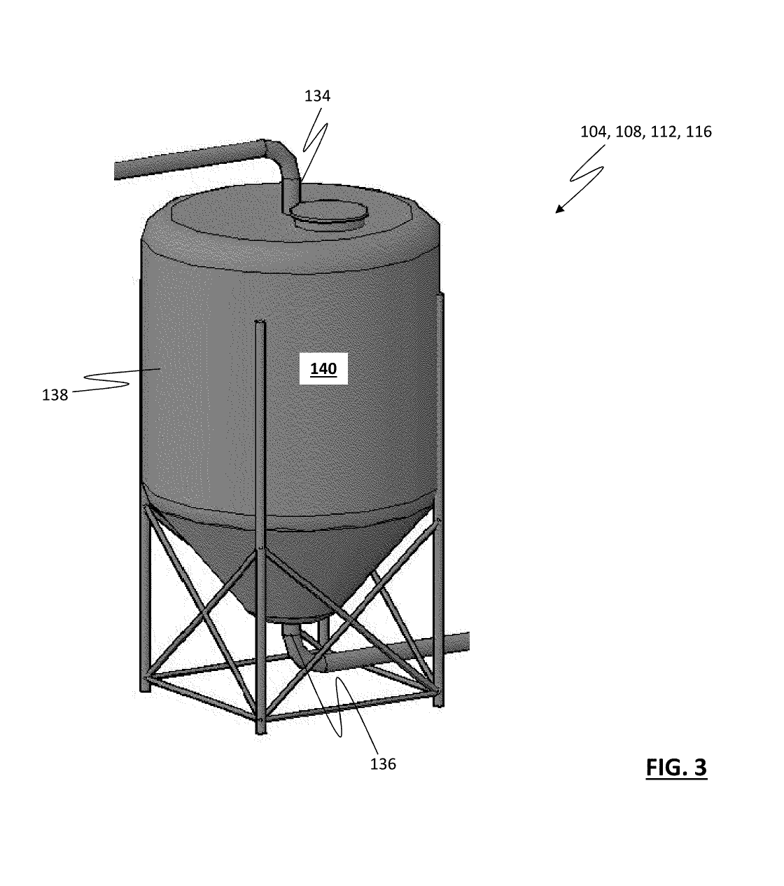

Referring to FIG. 1, a Fluid Purification System (FPS) 100 is shown in accordance with one embodiment of the invention and includes a system inlet 102, a first buffer tank 104, a first filter 106, a second buffer tank 108, a purification module 110, a third buffer tank 112, a second filter 114, a fourth buffer tank 116 and a system outlet 118. Referring to FIG. 2, the purification module 110 may include a module inlet 120, an injection manifold 122, at least one monovalent (or singlet) oxygen O₁ generator 124 associated with at least one cooling loop 126 for the O₁ generator 124 (two are shown), an outboard O₂ generator 128 associated with the at least one cooling loop 126, a first contact chamber 130, a second contact chamber 131 and a module outlet 132. Referring to FIG. 3, a buffer tank 104, 108, 112, 116 is shown, wherein each of the first buffer tank 104, second buffer tank 108, third buffer tank 112 and/or fourth buffer tank 116 may include a buffer tank inlet 134, a buffer tank outlet 136 and a buffer tank structure 138 that defines a buffer tank chamber 140 that communicates the buffer tank inlet 134 with the buffer tank outlet 136, wherein the buffer tank chamber 140 is configured to controllably contain fluid that enters the buffer tank inlet 134. In the present embodiment, each of the first and second contact chambers 130, 131 is approximately 120 feet in length and is configured such that the flow path of the first contact chamber 130 is parallel to the flow path of the second contact chamber 131. Thus, in one embodiment, time for the first ounce of fluid that enters the contact chamber section 130, 131 to exit the contact chamber section 130, 131 is about 12.4 seconds. In other embodiment, this time may change based on the configuration of the contact chamber(s). Accordingly, the contact chamber may be designed to be longer or shorter than 120 feet to increase/decrease mixing time as desired and the type of bends and number of bends may be configured to accomplish an adequate amount of mixing as desired. The bends may be any degree between 0° and 360° as desired.

Moreover, it should be appreciated that although the Fluid Purification System (FPS) 100 is shown as having the first, second, third and fourth buffer tanks 104, 108, 112, 116, it is contemplated that in other embodiments, the Fluid Purification System (FPS) 100 may not have any buffer tanks, as desired. As such, the fluid would flow directly between each stage without any buffer tanks. Additionally, it is contemplated that in some embodiments the Fluid Purification System (FPS) 100 may not use any pumps to keep the fluid flowing between stages and in other embodiments one or more pumps may be used to keep the fluid flowing between stages as desired.

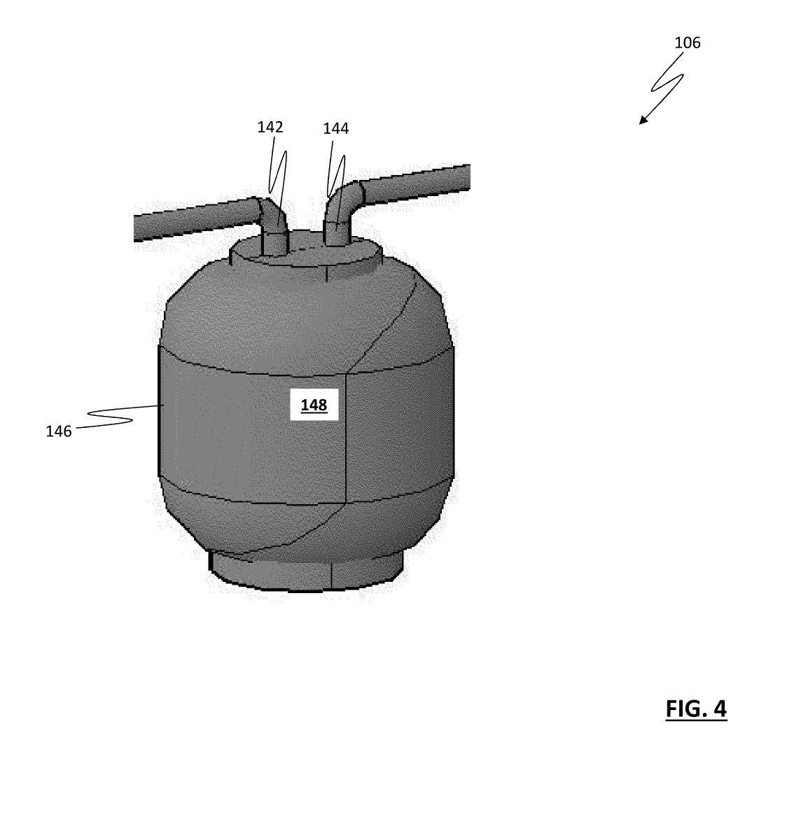

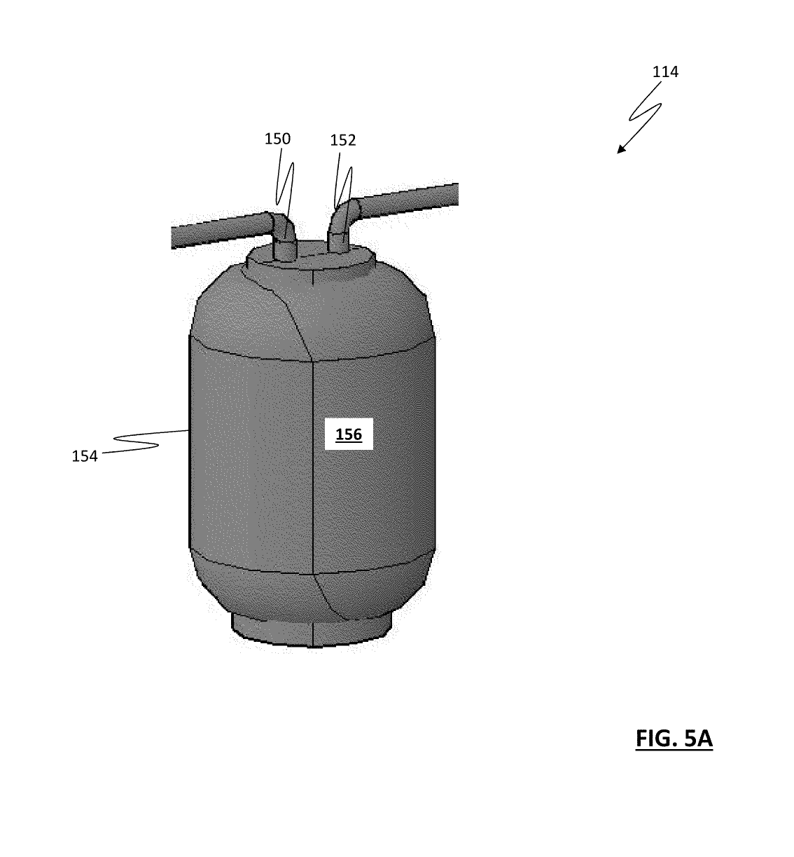

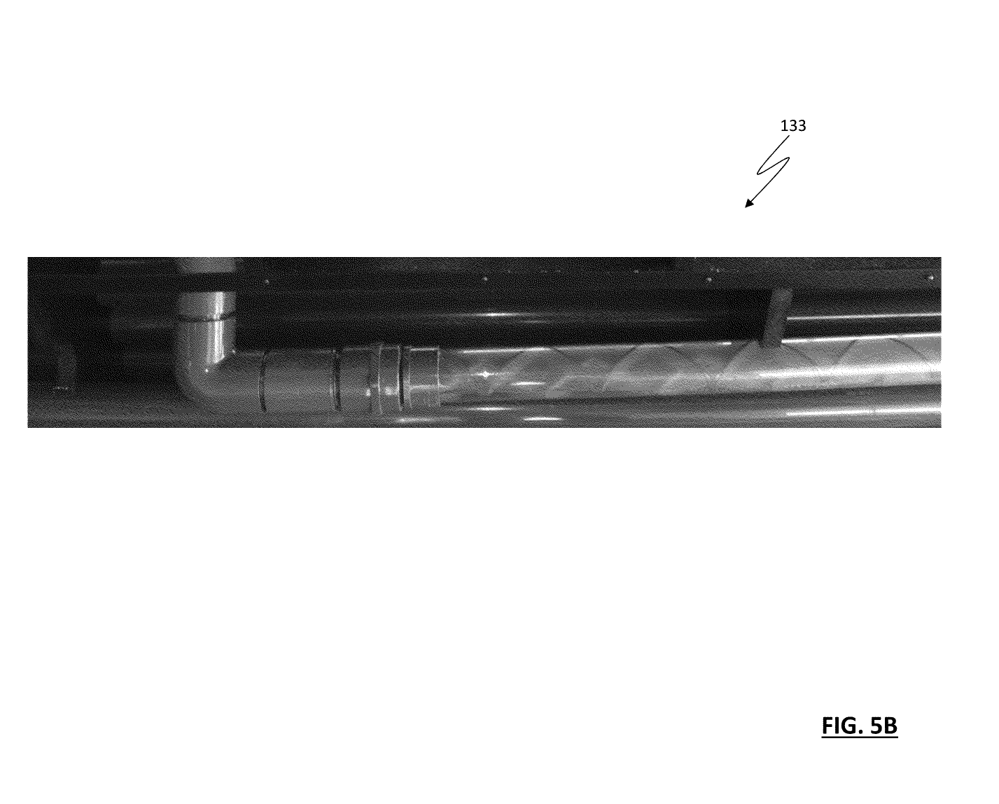

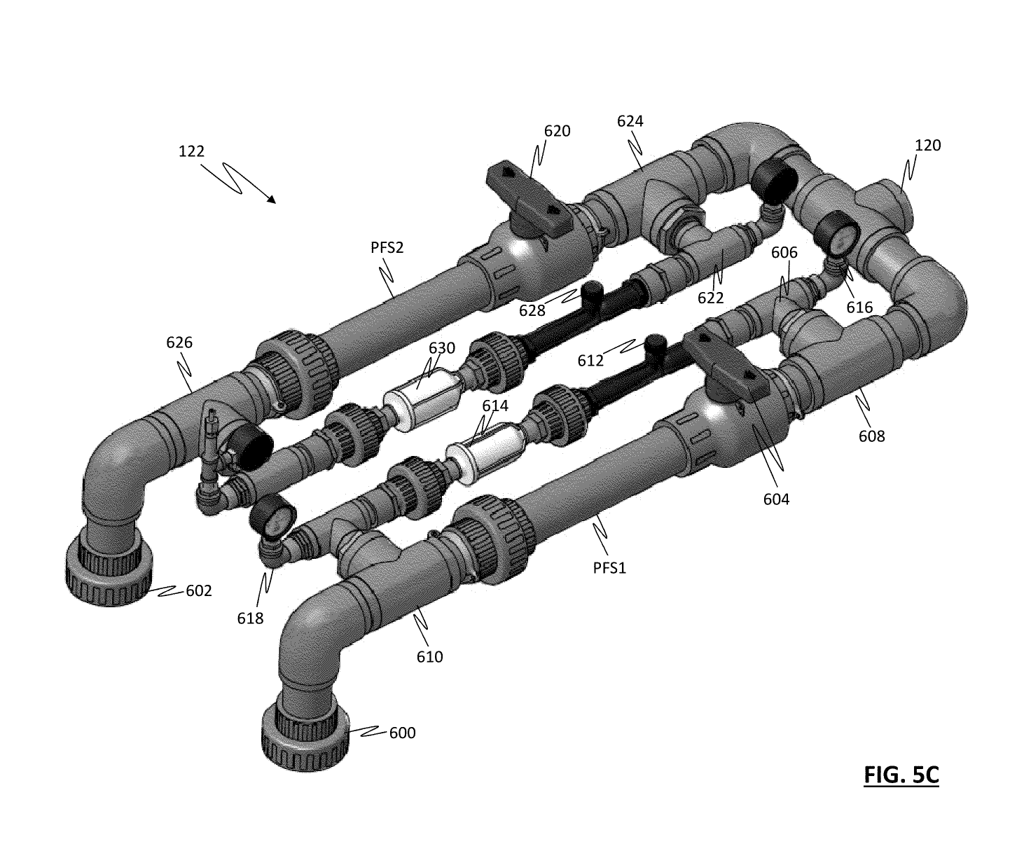

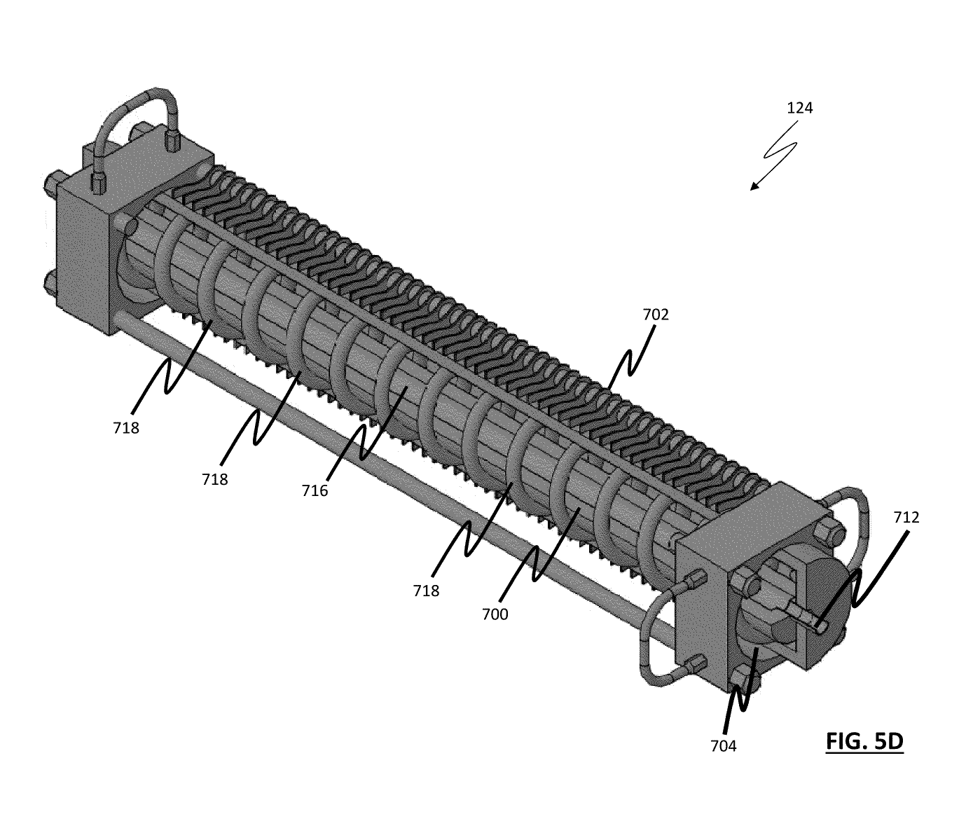

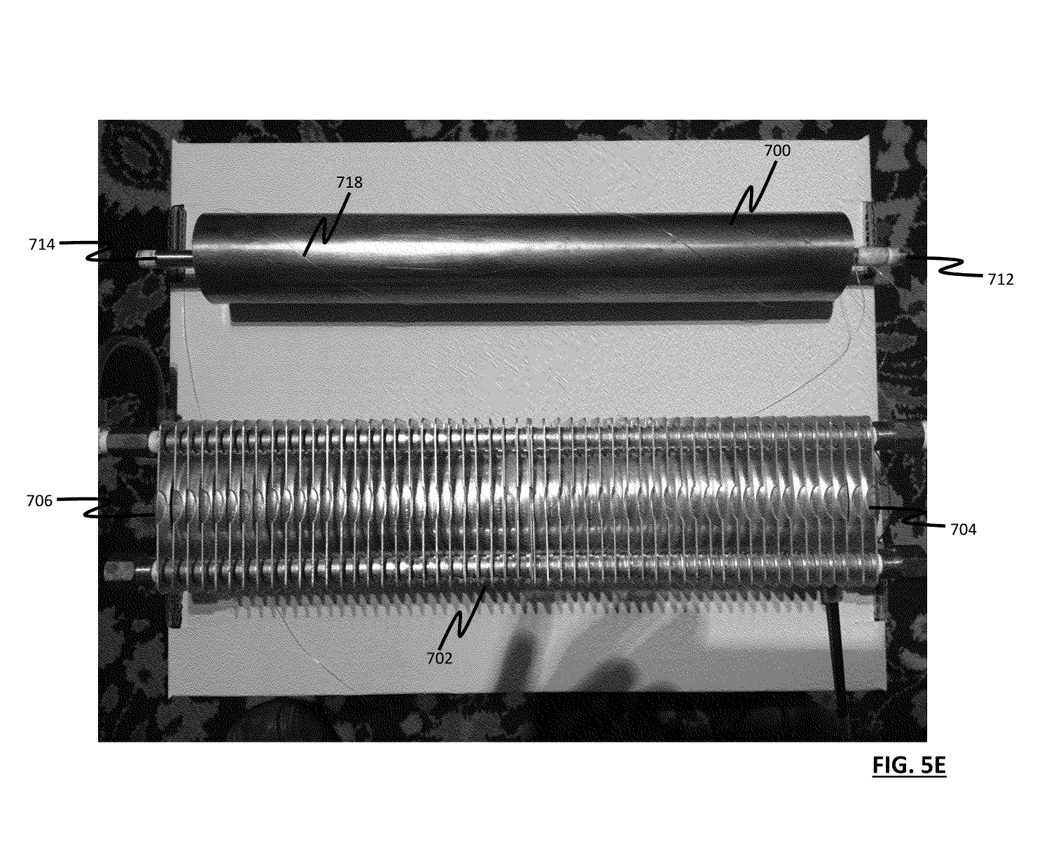

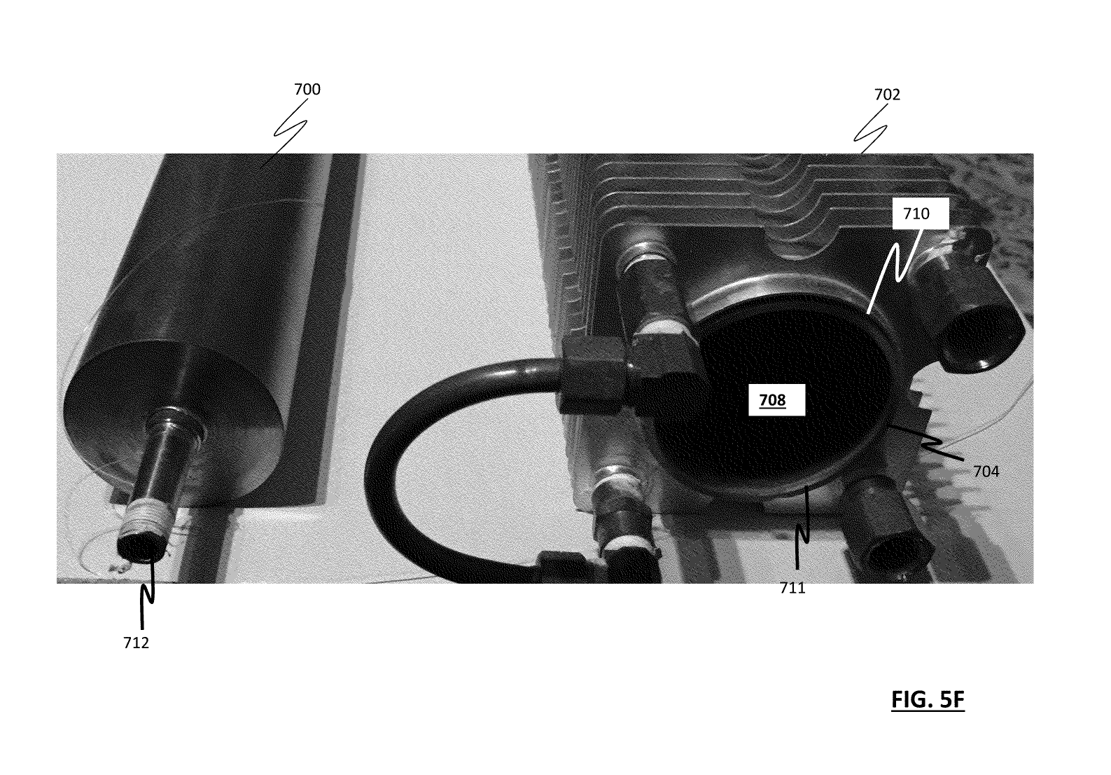

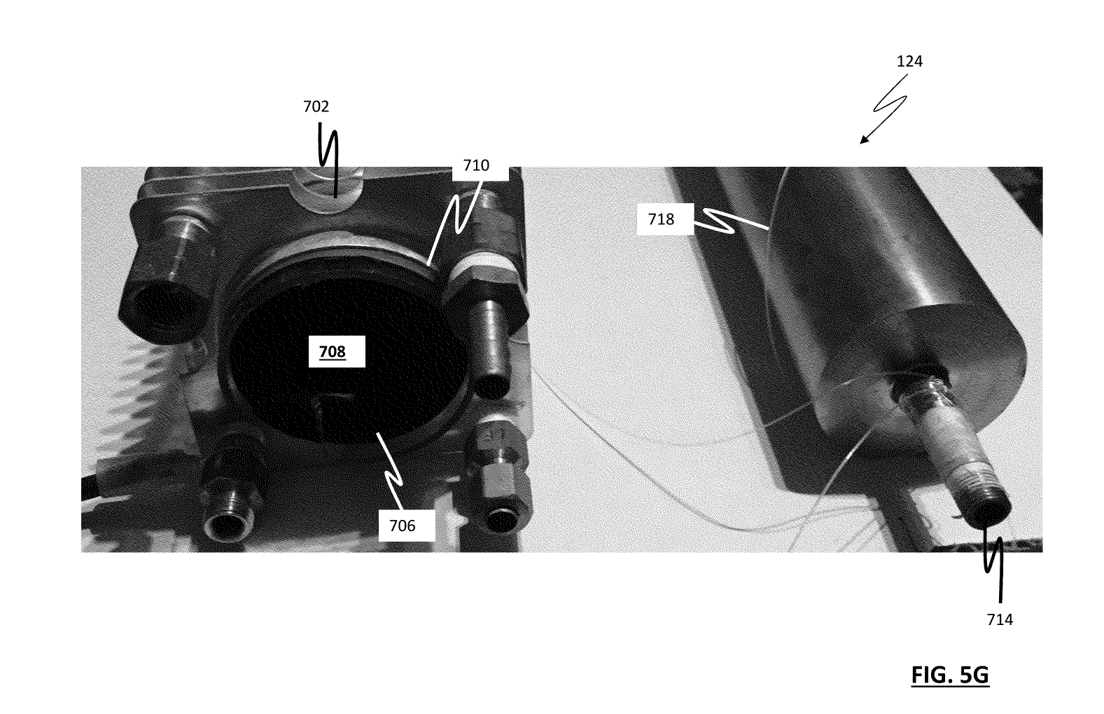

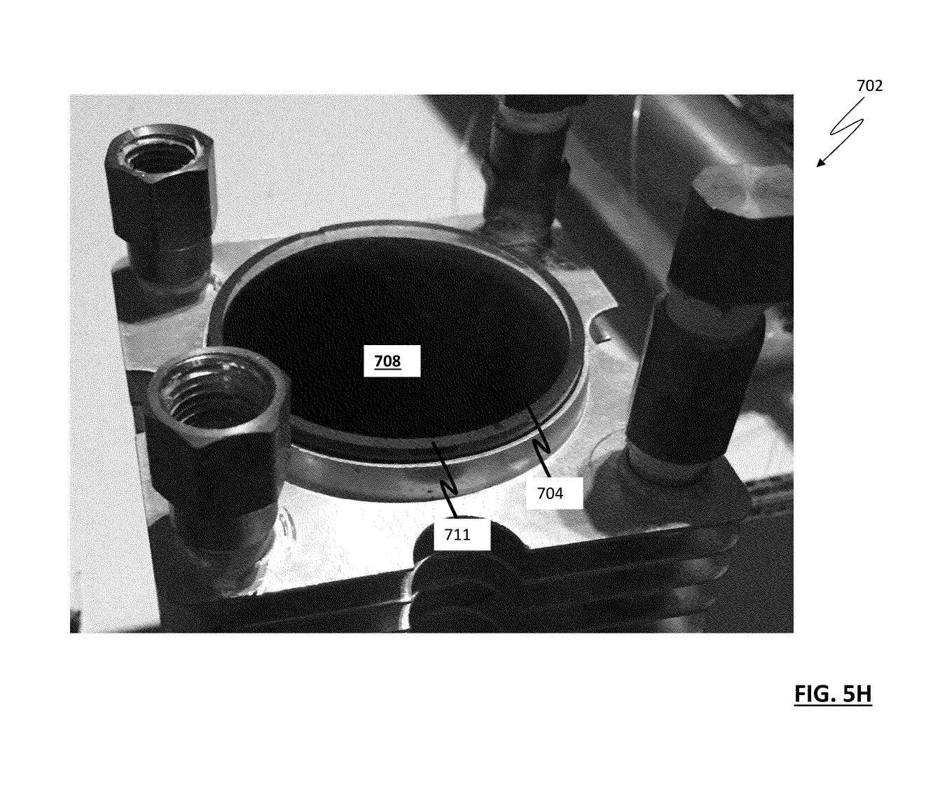

Referring to FIG. 4, the first filter 106 is shown and may include a first filter inlet 142, a first filter outlet 144 and a first filter structure 146 which defines a first filter cavity 148 for containing a filtration system, wherein the first filter inlet 142 and first filter outlet 144 are communicated with the filtration system such that fluid entering the first filter inlet 142 is filtered by the filtration system and exits out of the first filter outlet 144. Referring to FIG. 5, the second filter 114 is shown and may include a second filter inlet 150, a second filter outlet 152 and a second filter structure 154 which defines a second filter cavity 156 for containing a filtration system, wherein the second filter inlet 150 and second filter outlet 152 are communicated with the filtration system such that fluid entering the second filter inlet 150 is filtered by the filtration system and exits out of the second filter outlet 152.

Referring again to FIGS. 1-5, the FPS 100 may be arranged as follows. The system inlet 102 is disposed to be in flow communication with the buffer tank inlet 134 of the first buffer tank 104. The buffer tank outlet 136 of the first buffer tank 104 is in flow communication with the first filter inlet 142 of the first filter 106 and the first filter outlet 144 of the first filter 106 is in flow communication with the buffer tank inlet 134 of the second buffer tank 108. The buffer tank outlet 136 of the second buffer tank 108 is in flow communication with the module inlet 120 of the purification module 110 and the module outlet 132 of the purification module 110 is in flow communication with the buffer tank inlet 134 of the third buffer tank 112. The buffer tank outlet 136 of the third buffer tank 112 is in flow communication with the second filter inlet 150 of the second filter 114 and the second filter outlet 152 of the second filter 114 is in flow communication with the buffer tank inlet 134 of the fourth buffer tank 116.

Referring again to FIG. 2, the purification module 110 may be arranged and may operate as follows. The module inlet 120 is in further flow communication with the injection manifold 122, wherein the injection manifold 122 is also associated with the at least one singlet oxygen O₁ generator 124 such that O₁ is injected into the fluid flow at the injection manifold 122 to ‘interact’ with the fluid stream flowing into the injection module inlet 120. The injection manifold 122 is configured to split the fluid flow into two pressurized fluid streams (PFS1 and PFS2) and inject O₁ into each of the fluid streams, PFS1/PFS2, where one fluid stream PFS1/O₁ combination is directed to flow through the first contact chamber 130 and the other fluid stream PFS2/O₁ combination is directed to flow through the second contact chamber 131. The first contact chamber 130 and second contact chamber 131 are configured to have multiple 180° (and/or 90°) bends in the flow path to maintain fluid turbulence and such that the flow path is sufficiently long to lengthen mixing time. Additionally, each of the first and second contact chambers 130, 131 include inline static mixers 133 (See FIG. 5B) for increasing/maintaining level of fluid turbulence. The outlet of each of the first contact chamber 130 and second contact chamber 131 are in flow communication with the module outlet 132, such that the fluid flowing in the first contact chamber 130 and the fluid flowing in the second contact chamber 131 remix together and flow out of the module outlet 132 and into the buffer tank inlet 134 of the third buffer tank 112.

It should be appreciated that in at least one embodiment, different types of mixers may be used in the FPS 100. One type of mixer that may be used is a “flash reactor” located immediately after the venturi injectors in the injection manifold 122. This creates nano-bubbles in the fluid stream which greatly enhances the surface area of gas in the fluid stream, thus creating a substantial increase in the kill rate of biological contaminants. The second type of mixer is the static mixer 133 (see FIG. 5B) which provides an inline mixing potential of about one million turns in the fluid stream as it passes through the static mixer 133. Moreover, all of the 180 degree bends in the flow tubes of the first contact chamber 130 and second contact chamber 131 causes the fluid to mix as the fluid strikes each turn. Moreover, if desired “active” type mixers may also be used as desired.

Referring again to FIGS. 1-5, the FPS 100 operates as follows. A fluid to be purified is introduced into the system inlet 102 and flows into the first buffer tank 104 via the buffer tank inlet 134. The first buffer tank 104 helps to ensure a continuous and even fluid flow into the first filter 106 by dampening any disturbances that may be present in the initial fluid flow. The fluid flows out of the first buffer tank 104 and into the first filter 106 where the first filter 106 filters out any large particulates (greater than about 11 microns) that may be present in the fluid. This may be referred to as a “pre-filter” stage. The ‘pre-filtered’ fluid then flows out of the first filter 106 and into the second buffer tank 108, which dampens any disturbances that may be present in the ‘pre-filtered’ fluid flow. The ‘pre-filtered’ fluid then flows out of the second buffer tank 108 and into the purification module 110, where again the second buffer tank 108 helps to ensure a continuous and even fluid flow into the purification module 110. Typically, the filter(s) are normally selected based upon the application of the particular client, but it should be appreciated that any type of filter suitable to the desired end purpose may be used as desired. Some examples of filters that may be used are hydrocyclone, sand, multi-media, organic clay, carbon and/or membrane filters. However, the invention is not limited to any particular filter and/or method of filtration.

As the fluid flows into the module inlet 120 of the purification module 110, the injection manifold 122 divides the fluid flow into a first fluid flow stream PFS1 and a second fluid flow stream PFS2 and directs the first fluid flow stream PFS1 to flow into and through the first contact chamber 130 and the second fluid flow stream PFS2 to flow into and through the second contact chamber 131, where the injection manifold 122 pressurizes and injects O₁ into the first and second fluid flow streams, PFS1, PFS2, respectively. As the first and second fluid flow streams, in combination with the injected O₁, flow through the first and second contact chambers 130, 131 the configuration of the contact chamber flow path causes the fluid and injected O₁ to mix. This mixing may be accomplished via the natural flow of the fluid through the contact chambers 130, 131 as well as via inline static mixers 133 which may be located within the first and/or second contact chambers 130, 131 to be positioned inline with the fluid flow path. When the fluid flow stream/injected O₁ mixture reach the end of the first and second contact chambers 130, 131, the fluid flow stream/injected O₁ mixture from the first and second contact chambers 130, 131 are combined together and flow out of the module outlet 132 and into the third buffer tank 112. The fluid then flows out of the third buffer tank 112 and into the second filter 114, where the second filter 114 filters out the small particulates (about 2 micron-about 10 microns). It should be appreciated that similar to the above, the third buffer tank 112 dampens any disturbances that may be present in the fluid flowing out of the module outlet 132 and helps to ensure a continuous and even fluid flow into the second filter 114. This may be referred to as a “post-filter” stage. The ‘post-filtered’ fluid then flows out of the second filter 114 and into the fourth buffer tank 116. The ‘post-filtered’ fluid then flows out of the fourth buffer tank 116, out of the system outlet 118 and into a storage tank for future use.

It should be appreciated that one or more pumping devices may be used to support the pressure drop normally associated with a media type filter and to keep the fluid flowing through each stage of the FPS 100. For example, a pumping device may be located external and prior to the first filter 106, second filter 114 and/or purification module 110. Referring to FIG. 5C, an injection manifold 122 is shown in accordance with one embodiment of the invention and includes a module fluid inlet 120 which splits the fluid flowing into the module fluid inlet 120 into a first fluid flow stream PFS1 and a second fluid flow stream PFS2. The injection manifold 122 also includes a first fluid outlet 600 communicated with the first fluid flow stream PFS1 and a second fluid outlet 602 communicated with the second fluid flow stream PFS2. The injection manifold 122 further includes a first flow control valve 604 located in line with the first fluid flow stream PFS1 and a first gas/fluid flow path 606 which is in flow communication with the first fluid flow stream PFS1 via a first T-pipe 608 and a second T-pipe 610, wherein the first T-pipe 608 is located prior to the first flow control valve 604 and the second T-pipe 610 is located after the first flow control valve 604. The first T-pipe 608 and first flow control valve 604 advantageously allows a portion of the fluid flowing in the first fluid flow stream PFS1 to be controllably diverted into the first gas/fluid flow path 606 (wherein the volume of the diverted flow is controlled by the control valve 604) and the second T-pipe 610 advantageously allows the fluid/gas combination flowing in the first gas/fluid flow path 606 to be recombined with the fluid flowing in the first fluid flow stream PFS1. The injection manifold 122 also includes a first venturi injector 612 associated with the singlet oxygen O₁ generator 124 to receive singlet oxygen O₁, and a first flash reactor 614 located in-line with the first gas/fluid flow path 606. Also, the injection manifold 122 includes a first gas/fluid flow path pressure sensor 616 associated with the first T-pipe 608 to measure the pressure at the first T-pipe 608 and a second gas/fluid flow path pressure sensor 618 associated with the second T-pipe 610 to measure the pressure at the second T-pipe 610.

The injection manifold 122 further includes a second flow control valve 620 located in line with the second fluid flow stream PFS2 and a second gas/fluid flow path 622 which is in flow communication with the second fluid flow stream PFS2 via a third T-pipe 624 and a fourth T-pipe 626, wherein the third T-pipe 624 is located prior to the second flow control valve 620 and the fourth T-pipe 626 is located after the second flow control valve 620. The third T-pipe 626 and second flow control valve 620 advantageously allows a portion of the fluid flowing in the second fluid flow stream PFS2 to be controllably diverted into the second gas/fluid flow path 622 (wherein the volume of the diverted flow is controlled by the control valve 620) and the fourth T-pipe 626 advantageously allows the fluid/gas combination flowing in the second gas/fluid flow path 622 to be recombined with the fluid flowing in the second fluid flow stream PFS2. The injection manifold 122 also includes a second venturi injector 628 associated with the singlet oxygen O₁ generator 124 to receive singlet oxygen O₁, and a second flash reactor 630 located in-line with the second gas/fluid flow path 622. Also, the injection manifold 122 includes a third gas/fluid flow path pressure sensor 632 associated with the third T-pipe 624 to measure the pressure at the third T-pipe 624 and a fourth gas/fluid flow path pressure sensor 634 associated with the fourth T-pipe 626 to measure the pressure at the fourth T-pipe 626.

As fluid enters the injection manifold 122 via the module fluid inlet 120, the fluid is split into the first and second fluid flow paths PFS1, PFS2. The first control valve 604 and second control valve 620 are adjusted to cause a portion of the fluid flowing through PFS1 and PFS2 to flow into the first and second gas/fluid flow path 606, 622, respectively. The first and second venturi injectors 612, 628 inject singlet oxygen O₁ into the first and second gas/fluid flow path 606, 622, respectively to mix with the fluid flowing within the first and second gas/fluid flow path 606, 622. The fluid/O₁ combination then flows through the first and second flash reactors (i.e. a high compression baffling systems) 614, 630 to create nano-bubbles in the fluid stream flowing through the first and second gas/fluid flow path 606, 622. The fluid/O₁ combination flowing through the first and second gas/fluid flow path 606, 622 is then reintroduced into the first and second fluid flow paths PFS1, PFS2 via the second and fourth T-pipes 610, 626 and allowed to discharge via the first and second fluid outlets 600, 602.

It should be appreciated that each fluid flow stream is regulated by the control valves 604, 620 so as to ensure substantially equal flow and pressure across the entire injection manifold 122. The control valves 604, 620 also act as a means to ensure that the pressure drop across the injection flow path is maintained to enable optimized injection of the processed gas (i.e. O₁). As the portion of the liquid flow stream is diverted by the control valves 604, 620 into the injection flow path (i.e. into first contact chamber 130 and second contact chamber 131), the processed gas is introduced into the fluid via the venturi injectors as discussed above. After the processed gas is injected into the flow stream via the venturi injectors, the liquid/gas mix is passed through the flash reactors (i.e. a high compression baffling system) to create nano-bubbles in the fluid stream. This advantageously allows the invention to achieve a far greater surface area for mixing liquid/gas stream than current systems. This portion of the liquid flow stream is then reintroduced into the main liquid flow path and directed to exit the injection manifold 122 into the contact chamber section for further mixing and contact time prior to the re-combining of fluid streams and exiting from the purification module 110.

It should be appreciated that in at least one embodiment, a pressure difference between the first gas/fluid flow path pressure sensor 616 and the second gas/fluid flow path pressure sensor 618 should be approximately 10 PSI and a pressure difference between the third gas/fluid flow path pressure sensor 632 and the fourth gas/fluid flow path pressure sensor 634 should also be approximately 10 PSI. In at least one embodiment, these pressure differences should be substantially equal to each other. It is contemplated that pressure differences less than or greater than about 10 PSI may also be used. It should also be appreciated that the invention is not limited to two fluid flow paths PFS1, PFS2. In additional embodiments any number of flow paths as desired and suitable to the desired end purpose may be used, such as one flow path and/or three or more flow paths.

Referring to FIG. 5D, FIG. 5E, FIG. 5F, FIG. 5G and FIG. 5H, a unique and novel singlet oxygen O₁ generator 124 (such as a plasma generator) is provided and includes an inner element 700 and an outer element 702. The outer element 702 includes a first opening 704, a second opening 706 and defines an inner cavity 708 having an inner cavity wall 710, wherein the inner cavity 708 extends the length of the outer element and communicates the first opening 704 with the second opening 706. The singlet oxygen O₁ generator 124 further includes an insulation tube 711, which is constructed from a dielectric material such as quartz glass (or any other suitable dielectric, insulating material or combination of materials, such as ceramic) which is located within the inner cavity 708 to cover the inner cavity wall 710. The inner element 700 includes an inner element first opening 712 and an inner element second opening 714 and defines an inner element cavity 716 which extends the length of the inner element 700 and communicates the inner element first opening 712 with the inner element second opening 714. The inner element first opening 712 and inner element second opening 714 are configured to be communicated with a coolant supply (such as chilled water from the at least one cooling loop 126) such that the coolant enters the inner element first opening 712 and exits the inner element second opening 714, thereby cooling the inner element 700. The singlet oxygen O₁ generator 124 further includes a flow control element 718 which is wrapped helically (spiral) around the outer surface of the inner element 700. The inner element 700 is sized and shaped to fit within the inner cavity 708 such that a 1.5 mm gap (space) exists between the outer surface of the inner element 700 and the surface of the quartz glass tube 710, while the flow control element 718 is in contact with the surface of the quartz glass tube 710. It should be appreciated that the inner element 700 with the flow control element 718 may be pressed fit into the inner cavity 708, wherein the flow control element 718 may be secured to the outer surface of the inner element 700 using an adhesive or other securing method and/or device. It is contemplated that in other embodiments, the flow control element 718 may be integrated with the outer surface of the inner element 700 and/or the surface of the quartz glass tube 710.

Once the inner element 700 is located within the inner cavity 708, the ends of the singlet oxygen O₁ generator 124 are sealed and the inner element 700 and the outer element 702 are charged such that a potential difference exists between the inner element 700 and the outer element 702. Oxygen O₂ is introduced, under pressure, to one end of the singlet oxygen O₁ generator 124 and the first opening 704 of the outer element 702. The pressure causes the oxygen O₂ to flow over the outer surface of the inner element 700 and into the inner cavity 708. The flow control element 718, which is wrapped spirally around the outer surface of the inner element 700 forces the Oxygen O₂ to flow through the inner cavity in a spiral manner thereby increasing the flow path and time spent within the inner cavity between the charged inner element 700 and outer element 702. A coolant (such as chilled water from the at least one cooling loop 126) is introduced into the inner element first opening 712, through the inner element cavity 716 and out of the inner element second opening 714 thereby evenly cooling the inner element 700. It should be appreciated that the flow control element 718 may be any non-conducting, ozone resistant material suitable to the desired end result, such as, for example, Teflon. Additionally, it is contemplated that the outer surface of the outer element 702 may include fins which extend out of and away from the outer surface of the outer element 702 to help dissipate heat and electrical charge.

It should be appreciated that in a preferred embodiment, the outer element 702 is constructed, at least in part, from machined or formed aluminum due to its weight and heat dissipation characteristics. It is contemplated that, in other embodiments, the outer element 702 may be constructed, at least in part, from any electrically conductive material or combination of materials suitable to the desired end purpose. Additionally, it should be appreciated that in a preferred embodiment, the inner element 700 is constructed, at least in part, from machined or rolled stainless steel due to its ability to handle a high heat load and its ability to be water cooled. It is contemplated that, in other embodiments, the inner element 700 may be constructed, at least in part, from any electrically conductive material or combination of materials suitable to the desired end purpose.

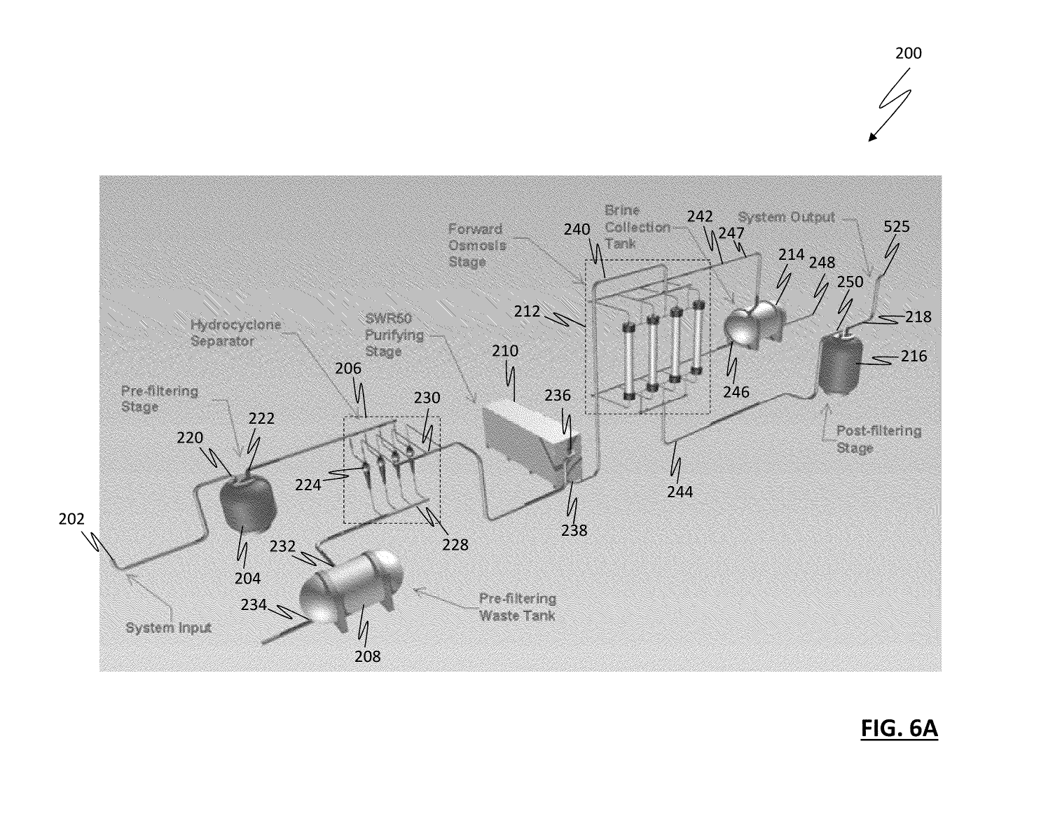

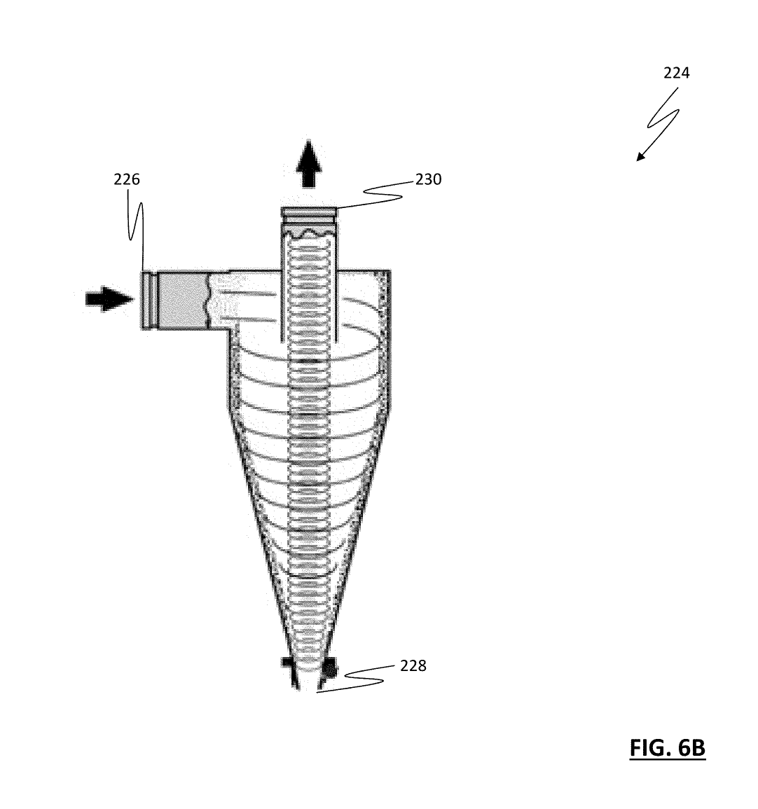

It should be appreciated that other embodiments of the invention are contemplated as well. Referring to FIG. 6A, a Fluid Purification System (FPS) 200 in accordance with another embodiment of the invention is shown and includes a system inlet 202, a first filter stage tank 204, a particulate removal stage 206 (which may include filtration devices, such as one or more hydrocyclone separators), a first filter waste tank 208, a purification module 210, a solute removal stage 212 (such as a forward Osmosis stage), a brine collection tank 214, a second filter stage 216 and a system outlet 218. The first filter stage 204 includes a first filter inlet 220 and a first filter outlet 222 and the particulate removal stage 206 may include one or more hydrocyclone separators 224, wherein each of the hydrocyclone separators 224 include a separator inlet 226, a separator waste outlet 228 and a separator fluid outlet 230 (See FIG. 6B). The filter waste tank 208 includes a filter waste tank inlet 232 and a filter waste tank outlet 234. The purification module 210 includes a module inlet 236 and a module outlet 238 and is arranged and operated in a similar manner as the purification module 110 discussed hereinabove. The solute removal stage 212 includes a solute removal stage inlet 240, a solute removal stage waste outlet 242 and a solute removal stage fluid outlet 244. Moreover, the brine collection tank 214 includes a first brine tank inlet 246, a second brine tank inlet 247 and a brine tank outlet 248 and the second filter stage 216 includes a second filter stage inlet 250 and a second filter stage outlet 252.

In accordance with an embodiment of the invention, the system inlet 202 is communicated with the first filter inlet 220 such that fluid flowing into the system inlet 202 flows into the first filter stage 204 via the first filter inlet 220. After the fluid is filtered by the first filter stage 204, the pre-filtered fluid flows out of the first filter outlet 222 and into the particulate removal stage 206 via separator inlets 226 of the hydrocyclone separators 224 of the particulate removal stage 206. The hydrocyclone separators 224 separate particulates from the pre-filtered fluid and the separated fluid is directed out of the separator fluid outlet 230 while the waste is directed out of the separator waste outlet 228 and into the filter waste tank 208 via the filter waste tank inlet 232. The separated fluid that is directed out of the separator fluid outlet 230 flows into the module inlet 236 where it is purified by the purification module 210, as discussed hereinabove, and then directed out of the module outlet 238. The purified fluid is then directed into the solute removal stage 212 via the solute removal stage inlet 240 where the fluid is processed (such as by a forward osmosis stage) to remove any dissolved solutes that may be present. The waste fluid from the solute removal stage 212 is directed out of the solute removal stage waste outlet 242 into the brine collection tank 214 via the brine tank inlet 246, 247 while the processed purified fluid is then directed out of the solute removal stage fluid outlet 244 and include the second filter stage 216 via the second filter stage inlet 250. Once the processed purified fluid is filtered by the second filter stage 216, the post-filtered fluid is directed out of the second filter stage outlet 252 for future use or storage.

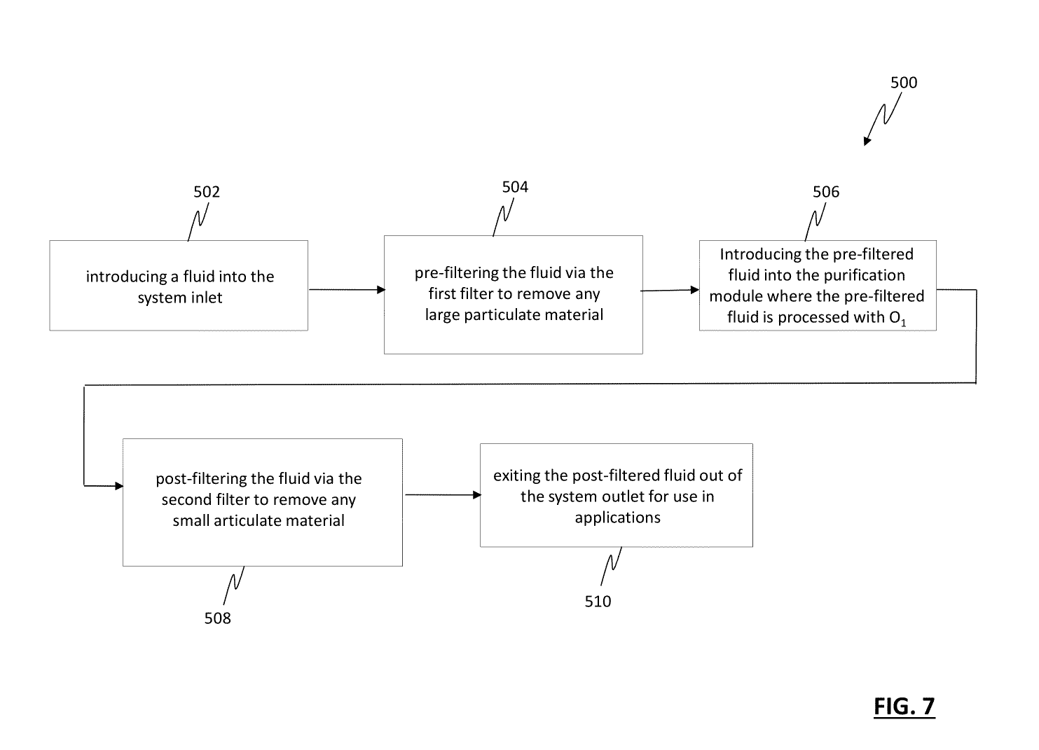

Referring to FIG. 7, an operational block diagram illustrating one embodiment of a method 500 for purifying a fluid is provided and includes introducing a fluid into a system inlet 102 of the Fluid Purification System (FPS) 100, 200, as shown in operational block 502. The fluid is then ‘pre-filtered’ via the first filter 106, 204 to remove any large particulate material (greater than about 11 microns), as shown in operational block 504. If desired, the ‘pre-filtered’ may be further filtered via an additional filtration stage, such as particulate removal stage 206. The ‘pre-filtered’ fluid is then introduced into the purification module 110, 210 where the ‘pre-filtered’ fluid is processed using singlet oxygen O₁, as shown in operational block 506. It should be appreciated that the purification module 110, 210 splits the fluid flow into first and second fluid flow streams, PFS1, PFS2 via twin piping circuits (i.e. first and second contact chambers 130, 131), to maximize volumetric efficiency and total contact area. The incoming O₂ from the outboard O₂ generator unit 128 is then processed by the O₁ generator 124 to generate singlet O₁ and the resulting singlet O₁ is injected via flash reactors/diffusers into the first and second fluid flow streams, PFS1, PFS2, flowing within the first and second contact chambers 130, 131, where the injected O₁ reacts in solution with the fluid as it flows through the first and second contact chambers 130, 131. The fluid flowing out of the purification module 110, 210 is then ‘post-filtered’ via the second filter 114, 216 to remove any smaller particulate material (about 2 microns to about 10 microns), as shown in operational block 508. It is contemplated that, if desired, the fluid flowing out of the purification module 110, 210 may be introduced to a solute removal stage 212 (such as a forward osmosis stage) before applying the fluid to a second filter 114, 216. The ‘post-filtered’ fluid (i.e. fluid filtered by second filter 114, 216) is then directed out of the system outlet 118, 218, as shown in operational block 510.

It should be appreciated that, in at least one embodiment, the purification module 110, 210 may include a plasma generator and the O₁ stream may be controlled through a plasma field by forcing the raw fuel (i.e. O₂) through a spiral twist conduit in the plasma generator that surrounds the inner electrode and outer electrode of the plasma generator. Additionally, the purification module 110, 210 may also include a feedback loop, a sensing device for sensing the O₁ concentration(s) and/or pressures in the fluid stream and/or an imaging device for counting actual bacteria within the fluid stream. The feedback loop may be connected to the outboard O₂ generator unit 128 where the outboard O₂ generator unit 128, the O₁ generator 124 and/or the plasma generator may be controlled, at least in part, responsive to the output of the sensing device(s) and/or imaging device(s). Thus, the generation of the O₁ is unique in that the generation of O₂ (via the outboard O₂ generator unit 128) may be controlled based on feedback derived from the feedback loop in the fluid stream utilizing the sensing device(s) and/or imaging device(s). Moreover, processed gas generation is unique in that the O₂ flow is forced through the spiral configuration in the plasma generator (i.e. corona plasma chamber) to ensure an even and thorough excitation within the plasma field. The processed gas generation is unique in that both plasma generation electrodes are cooled utilizing chiller driven cold water in separate closed loop chambers for optimization of processed gas production. As such, the system is designed for low power consumption and for total off grid solar operation.

Thus, the fluid to be processed enters the purification module 110, 210 under pressure first reaching the injection manifold 122 where the chilled water is directed into two (or more) substantially parallel paths (for example, first and second fluid flow streams, PFS1, PFS2). Each path may be balanced for flow rates equally (such as by closing off valves) or set as desired. The injection manifold 122 may incorporate paired injector elements and high pressure static mixers. The processed gas mixture is injected via the injector manifold 122 into the first and second fluid flow streams (PFS1, PFS2) 130, 131, in a parallel fashion utilizing the feedback loop which is monitoring the O₁ concentration (such as by using 4-20 mA sensor), the pressure of the fluid flow and/or the bacteria level (i.e. with a camera that counts (or estimates) the level of bacteria within the fluid stream) in the fluid. The first and second fluid streams exit from the injection manifold 122 and are forced under pressure into the first and second contact chambers 130, 131. The first and second contact chambers 130, 131 may further include inline static mixer elements to better mix the fluid stream and the singlet O₁. The FPS 100, 210 may further incorporate multiple bends (such as 180° bends) in the piping of the first and second contact chambers 130, 131 to help maintain fluid turbulence to enhance mixing of the fluid and injected gas (O₁). It should be appreciated that using this configuration of multiple bends, the length of the first and second contact chambers 130, 131 is maximized to lengthen the mixing time.

In accordance with at least one embodiment of the present invention, the method of the invention may be fully or partially automated, wherein the automation may be implemented, wholly or partially, by a controller operating in response to a machine-readable computer program. In order to perform the prescribed functions and desired processing, as well as the computations therefore (e.g. execution control algorithm(s), the control processes prescribed herein, and the like), the controller may include, but not be limited to, a processor(s), computer(s), memory, storage, register(s), timing, interrupt(s), communication interface(s), and input/output signal interface(s), as well as combination comprising at least one of the foregoing.

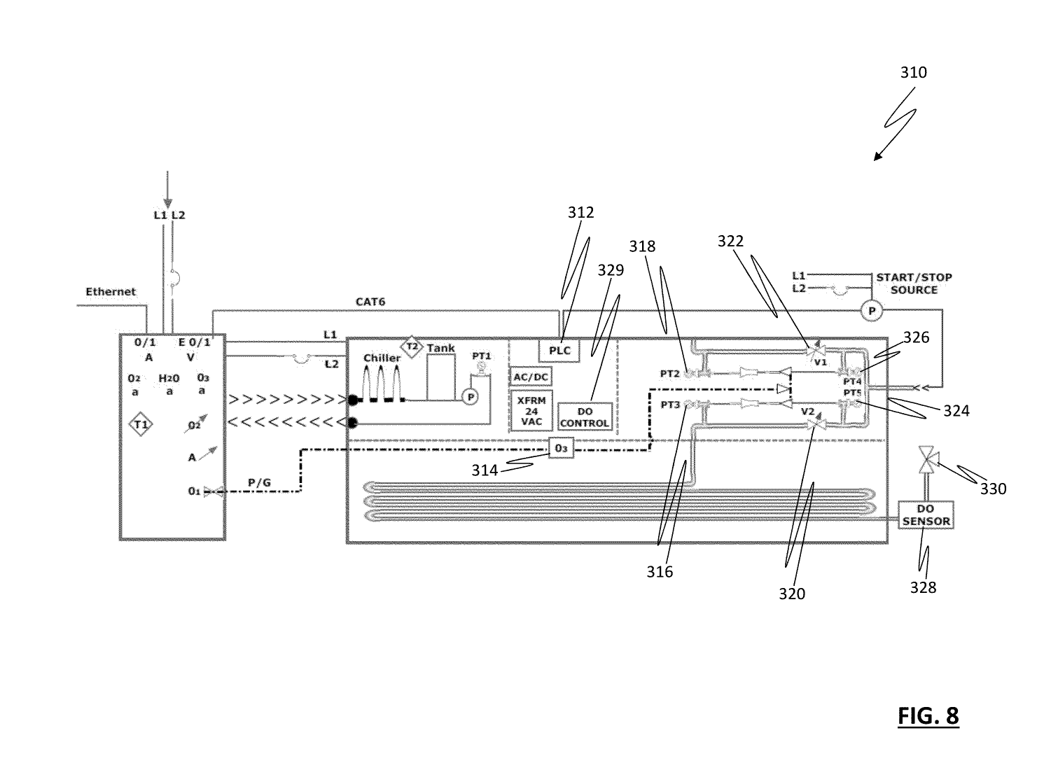

Referring to FIG. 8, a schematic block diagram of a purification module 310 which is configured for partial or full automation is shown in accordance with one embodiment of the invention. The purification module 310 is similar to purification modules 110, 210 with the addition of processing device 312 (such as a PLC controller), an O₃ monitor 314, a first flow pressure sensor 316, a second flow pressure sensor 318, a first main flow control valve 320, a second main flow control valve 322, a first main pressure sensor 324, a second main pressure sensor 326, a Dissolved Oxygen (DO) sensor 328, a DO controller 329 and a multi-way valve 330 (such as a three-way valve). It should be appreciated that the processing device 312 may be communicated with all or some of the O₃ monitor 314, the first flow pressure sensor 316, the second flow pressure sensor 318, the first main flow control valve 320, the second main flow control valve 322, the first main pressure sensor 324, the second main pressure sensor 326, the Dissolved Oxygen (DO) sensor 328 and the multi-way valve 330, to control their operation and/or to receive/transmit data from/to.

The first main pressure sensor 324 and second main pressure sensor 326 are configured such that the first main pressure sensor 324 measures the pressure of the fluid flowing within the first fluid flow stream (PFS1) 130 prior to the injection of O₁ into PFS1 via the injection manifold 122 and the second main pressure sensor 326 is configured to measure the pressure of the fluid flowing within the second fluid flow stream (PFS2) 131 prior to the injection of O₁ into PFS2 via the injection manifold 122.

Additionally, the first flow pressure sensor 316 and second flow pressure sensor 318 are configured such that the first flow pressure sensor 316 measures the pressure of the fluid flowing within the first fluid flow stream (PFS1) 130 after the injection of O₁ into PFS1 via the injection manifold 122 and the second flow pressure sensor 318 measures the pressure of the fluid flowing within the second fluid flow stream (PFS2) 131 after the injection of O₁ into PFS2 via the injection manifold 122. Moreover, the first main flow control valve 320 and second main flow control valve 322 are configured such that the first main flow control valve 320 controls the flow/pressure of the of the fluid in the first fluid flow stream (PFS1) 130 and the second main flow control valve 322 controls the flow/pressure of the of the fluid in the second fluid flow stream (PFS2) 131.

It should be appreciated that that the first flow pressure sensor 316, second flow pressure sensor 318, first main flow control valve 320, second main flow control valve 322, first main pressure sensor 324 and second main pressure sensor 326 are connected to the processing device 312 such that the processing device 312 receives pressure measurements from the first flow pressure sensor 316, second flow pressure sensor 318, first main pressure sensor 324 and second main pressure sensor 326 and controls the first main flow control valve 320 and second main flow control valve 322 based on those measurements. For example, the processing device 312 may control the first main flow control valve 320 based on the manifold pressure drop between the first main pressure sensor 324 and the first flow pressure sensor 316 and/or the second main flow control valve 322 based on the manifold pressure drop between the second main pressure sensor 326 and the second flow pressure sensor 318.

Additionally, the purification module 310 may also be configurable to optimize the process gas by monitoring the O₁ gas concentrations via the O₃ monitor 314 and automatic adjusting the O₂ gas injection via an O₂ gas flow controller and adjusting the power to the plasma chamber to creating an injectable gas concentration for sterilization of the incoming influent. It should be appreciated that this embodiment may include, one or more re-circulation circuits to re-direct the influent flow through one or more of the three-way automated valves 616 to allow the fluid to be repeatedly passed through and processed via the purification module 310 to optimize the fluid purity. Also, the fluid may be monitored for dissolved oxygen (DO) concentration the DO sensor 328 and the DO controller 329 may be operated to direct the fluid flow path to a re-circulation port of the three way valve 330 until a desired DO level is reached whereby the fluid may be allowed to pass to the discharge port of the three way valve 330.

Additionally, it should be appreciated that the invention disclosed herein may be applied and/or modified for any purpose desired. In one example, the fluid purification system 100, 200 may be installed on-board a vessel and may be used as a ballast water treatment system to destroy the biological contaminants and process the ballast water while underway. In another example, the fluid purification system 100, 200 may be used to remove contaminants from leachate from landfills for re-introduction of water into the ground water table. In yet another embodiment, the fluid purification system 100, 200 may be used to remove contaminants from fracking water from oil and gas. This may allow for a reduction and/or elimination of biocide injection into fracking water used in the oil and gas drilling industry. In still yet another example, the fluid purification system 100, 200 may be used in the field of hydroponics, where the source water treatment may increase total dissolved oxygen (DO) concentration to enhance plant growth by up to 20%. It should be appreciated that the above examples are only meant to demonstrate the broad scope of uses of the invention and are not meant to limit the invention to only those applications. As such, the invention may be used for the above applications in addition to a much wider scope of applications too numerous to list herein.

Moreover, the method(s) of the present invention may be embodied in the form of a computer or controller implemented processes. The method and/or algorithm of the invention may also be embodied in the form of computer program code containing instructions embodied in tangible media, such as floppy diskettes, CD-ROMs, hard drives, and/or any other tangible computer-readable medium, wherein when the computer program code is loaded into and executed by a computer or controller, the computer or controller becomes an apparatus for practicing the invention. The method and/or algorithm of the invention can also be embodied in the form of computer program code, for example, whether stored in a storage medium, loaded into and/or executed by a computer or controller, or transmitted over some transmission medium, such as over electrical wiring or cabling, through fiber optics, or via electromagnetic radiation, wherein when the computer program code is loaded into and executed by a computer or a controller, the computer or controller becomes an apparatus for practicing the invention. When implemented on a general-purpose microprocessor the computer program code segments may configure the microprocessor to create specific logic circuits.

It should be appreciated that while the invention has been described with reference to an exemplary embodiment, it will be understood by those skilled in the art that various changes, omissions and/or additions may be made and equivalents may be substituted for elements thereof without departing from the spirit and scope of the invention. In addition, many modifications may be made to adapt a particular situation or material to the teachings of the invention without departing from the scope thereof. For example, elements of one embodiment may be combined with elements of other embodiments to form additional embodiments as desired. Therefore, it is intended that the invention not be limited to the particular embodiment disclosed as the best mode contemplated for carrying out this invention, but that the invention will include all embodiments falling within the scope of the appended claims. Moreover, unless specifically stated any use of the terms first, second, etc. do not denote any order or importance, but rather the terms first, second, etc. are used to distinguish one element from another.

What is claimed is:

1. A fluid purification system, comprising:
a fluid inlet for receiving a fluid;
an injection manifold defining at least one manifold fluid flow path and at least one gas/fluid flow path, wherein the at least one gas/fluid flow path is in flow communication with the at least one manifold fluid flow part, the injection manifold being configured to receive the fluid flowing into the fluid inlet such that the fluid flowing into the fluid inlet flows through the at least one manifold fluid flow path, wherein the injection manifold is further configured to controllably divert at least a portion of the fluid flowing through the at least one manifold fluid flow path to flow through the at least one fluid/gas flow path and back into the at least one manifold fluid flow path;
a singlet oxygen generator for generating singlet oxygen O₁ communicated with the injection manifold such that the singlet oxygen O₁ is controllably injectable into the at least one gas/fluid flow path;
at least one contact chamber defining a contact chamber flow path, wherein the contact chamber is in flow communication with the at least one manifold fluid flow path to receive the fluid flowing within the at least one manifold fluid flow path; and
at least one fluid outlet in flow communication with the at least one contact chamber to allow fluid flowing within the at least one contact chamber to flow out of the at least one contact chamber.

2. The fluid purification system of claim 1, wherein the at least one manifold fluid flow path includes a first manifold fluid flow path and a second fluid flow path and wherein the at least one gas/fluid flow path includes a first gas/fluid flow path and a second gas/fluid flow path, wherein,
the first gas/fluid flow path is in fluid communication with the first manifold fluid flow path, and
the second gas/fluid flow path is in fluid communication with the second manifold fluid flow path.

3. The fluid purification system of claim 2, further comprising a first venturi injector, a second venturi injector, a first mixing device and a second mixing device.

4. The fluid purification system of claim 3, wherein the first injector venturi is associated with the singlet oxygen generator and the first gas/fluid flow path to controllably inject the singlet oxygen O₁ into the first gas/fluid flow path and wherein the second injector venturi is associated with the singlet oxygen generator and the second gas/fluid flow path to controllably inject the singlet oxygen O₁ into the second gas/fluid flow path

5. The fluid purification system of claim 4, wherein the first mixing device is associated with the first gas/fluid flow path to be located downstream from the first injector venturi and wherein the second mixing device is associated with the second gas/fluid flow path to be located downstream from the second injector venturi.

6. The fluid purification system of claim 2, wherein the at least one contact chamber includes a first contact chamber having a first contact chamber flow path and a second contact chamber having a second contact chamber flow path, wherein the first contact chamber flow path is in flow communication with the first manifold fluid flow path and wherein the second contact chamber flow path is in flow communication with the second manifold fluid flow path.

7. The fluid purification system of claim 6, wherein the first contact chamber and the second contact chamber is a predetermined length and includes multiple bends in the first contact chamber flow path and the second contact chamber flow path.

8. The fluid purification system of claim 7, further comprising a first static mixing device located in line with the first contact chamber flow path and a second static mixing device located in line with the second contact chamber flow path.

9. The fluid purification system of claim 1, further comprising a first flow control valve located in line with the first manifold fluid flow path and a second flow control valve located in line with the second manifold fluid flow path.

10. The fluid purification system of claim 9, wherein the first flow control valve is configured such that when the first flow control valve is operated, a portion of the fluid flowing within the first manifold fluid flow path is diverted into the first gas/fluid flow path and wherein the second flow control valve is configured such that when the second flow control valve is operated, a portion of the fluid flowing within the second manifold fluid flow path is diverted into the second gas/fluid flow path.

11. The fluid purification system of claim 1, wherein the singlet oxygen generator includes an outer element defining an outer element cavity having an insulator tube located therein, an inner structure having an inner structure outer surface, and a flow control element,
wherein an electrical potential difference exists between the outer element and the inner structure; and
wherein the flow control element is associated with the inner structure outer surface to be wrapped around the inner structure outer surface in a spherical fashion such that when the inner structure is located within the outer element cavity, a space exists between the inner structure outer surface and the insulator tube and wherein the flow control element is in contact with both the inner structure outer surface and the insulator tube such that when oxygen is directed to flow through the outer element cavity the flow control element directs the flow of oxygen through the outer element cavity.

12. A singlet oxygen generator for generating singlet oxygen O₁, the singlet oxygen generator comprising:
an outer element having an outer element first end, an outer element second end, an outer element first opening and an outer element second opening, wherein the outer element defines an outer element cavity having an outer element cavity surface and extends between the outer element first end and the outer element second end to communicate the outer element first opening with the outer element second opening;
an inner structure having an inner structure outer surface, an inner structure first end, an inner structure second end, an inner structure first opening and an inner structure second opening, wherein the inner structure defines an inner structure cavity which extends between the inner structure first end and the inner structure second end to communicate the inner structure first opening with the inner structure second opening, wherein the inner structure is configured to fit within the outer element cavity such that the inner structure outer surface is separated from the outer element cavity surface by a predetermined space; and
a flow control element, wherein the flow control element is associated with the inner structure outer surface to be located between the inner structure outer surface and the outer element cavity surface.

13. The singlet oxygen generator of claim 12, wherein the outer element first end and outer element second end are configured such that when a positive pressure of oxygen O₂ is applied to the outer element first end, the oxygen O₂ is forced to flow into and through the outer element cavity between the inner structure outer surface and the outer element cavity surface and exit out of the outer element second end.

14. The singlet oxygen generator of claim 12, further comprising an insulation tube disposed within the outer element cavity to be located between the inner structure outer surface and the outer element cavity surface, wherein the flow control element is touching both the inner structure outer surface and the insulation tube when the inner structure is located within the outer element cavity.

15. The singlet oxygen generator of claim 12, wherein the outer element and the inner structure are constructed from a conductive material and wherein an electrical potential difference exists between the outer element and the inner structure.

16. The singlet oxygen generator of claim 12, wherein the inner structure first opening is configured to receive a coolant such that the coolant flows through the inner structure cavity and out of the inner structure second end.

17. A method for purifying a fluid via a fluid purification system, wherein the fluid purification system includes an injection manifold defining a first fluid flow path, a first gas/fluid flow path, a second fluid flow path, a second gas/fluid flow path, a first contact chamber, a second contact chamber and at least one fluid outlet in flow communication with the first and second contact chambers to allow fluid flowing within the first and second contact chambers to flow out of the first and second contact chambers, the method comprising:
introducing the fluid into the injection manifold of the fluid purification system such that the fluid flow is split into a first fluid flow flowing in a first fluid flow path and a second fluid flow flowing in a second fluid flow path;
diverting at least a portion of the first fluid flow flowing in the first fluid flow path to flow in the first gas/fluid flow path and at least a portion of the second fluid flow flowing in the second fluid flow path to flow in the second gas/fluid flow path;
injecting singlet oxygen O₁ into the first and second gas/fluid flow paths to generate a fluid having a combination of fluid and gas flowing through the first and second gas/fluid flow paths;
directing the gas/fluid combination flowing within the first gas/fluid flow paths through a first mixing device to generate a first mixed gas/fluid combination and the gas/fluid combination flowing within the second gas/fluid flow paths through a second mixing device to generate a second mixed gas/fluid combination;
combining the first mixed gas/fluid combination with the first fluid flow to generate a first combined gas/fluid flow mix and the second mixed gas/fluid combination with the second gas/fluid flow to generate a second combined gas/fluid flow mix; and
directing the first combined gas/fluid flow mix through the first contact chamber and the second combined gas/fluid flow mix through the second contact chamber.

18. The method of claim 17, wherein injecting singlet oxygen O₁ into the first and second gas/fluid flow paths includes injecting the singlet oxygen O₁ into the first and second gas/fluid flow paths via a first and second venturi.

19. The method of claim 17, wherein diverting at least a portion of the first fluid flow and second fluid flow includes,
adjusting a first flow control valve to cause a portion of the first fluid flow to flow into the first gas/fluid flow path, and
adjusting a second flow control valve to cause a portion of the second fluid flow to flow into the second gas/fluid flow path.

20. The method of claim 17, wherein,
directing the first combined gas/fluid flow mix through the first contact chamber includes causing the first combined gas/fluid flow mix to flow through a first static mixing device, and
directing the second combined gas/fluid flow mix through the second contact chamber includes causing the second combined gas/fluid flow mix to flow through a second static mixing device.
